(19) United States
(12) Patent Application Publication
(10) Pub. No.: US 2009/0233201 A1
(43) Pub. Date: Sep. 17, 2009

(54) DEVELOPER AND IMAGE FORMING APPARATUS

(75) Inventor: Hiroshi Kawaguchi, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/405,397

(22) Filed: Mar. 17, 2009

Related U.S. Application Data
(60) Provisional application No. 61/037,050, filed on Mar. 17, 2008.

(51) Int. Cl. G03G 9/00; G03G 15/08

(52) U.S. Cl. 430/108.1; 430/108.7; 399/30; 399/254; 399/258; 399/44

(57) ABSTRACT

A developer to be used in an image forming apparatus has a carrier and a toner containing a colorant, a binder resin, a release agent, a charge controlling agent containing Al and Mg, and a conductive inorganic oxide having an intrinsic resistivity of from 1.0×10³Ω to 1.0×10¹⁰Ω in an amount of from 0.2 to 2.0 wt % based on a core toner.

### CROSS-REFERENCE TO RELATED APPLICATION

This application is based upon and claims the benefit of priority from the prior U.S. Patent Application No. 61/037,050 filed on Mar. 17, 2008, the entire contents of which are incorporated herein by reference.

### TECHNICAL FIELD

The present invention relates to a developer and an image forming apparatus to be used for forming an image by an electrophotographic system such as a copier or a printer.

### BACKGROUND

In an image forming apparatus of an electrophotographic system, a two-component developer containing a toner and a magnetic carrier for charging the toner is used. In a developing device using such a two-component developer, a toner is consumed as a developing operation proceeds, therefore, a toner in an amount corresponding to the consumed amount of toner is replenished. However, as for a carrier, it is difficult to maintain an initial condition such as to maintain a desired charging property due to its deterioration.

For preventing deterioration of a carrier and prolonging the service life of a developer, various studies are conducted to obtain a high-performance developer by optimizing formulation and production method for a toner, and core material, coating material and production method for a carrier. For example, JP-A-2005-315907 describes that coat peeling is suppressed by optimizing a coating material.

On the other hand, for further prolonging the service life of a developer in a developing device using such a two-component developer, a self-refreshing system is used. The self-refreshing system is, as disclosed in JP-A-2003-15418, a system in which a carrier in a developer which is deteriorated as a developing operation proceeds is evacuated and at the same time, a fresh carrier is replenished along with a toner. Since the carrier is replaced sequentially, the prolongation of the service life can be achieved as compared with the conventional system.

However, a replacing amount of the carrier varies depending on an amount of printing. For example, if printing is performed at extremely low coverage, the replacing amount significantly decreases. Therefore, a residence time of the carrier in the developing device is prolonged, and charging failure due to deterioration of the carrier may be caused in some cases. Accordingly, the toner is required to maintain a high charging property.

For obtaining a toner with a high charging property, various studies are conducted to optimize a charge controlling agent to be added to the toner. For example, US Patent Application Publication No. 2005/0277040 A1 discloses a charge controlling agent containing Al and Mg. However, even if such a charge controlling agent is merely added to a toner, it is difficult to properly control the charging property because the charge amount varies depending on a change in the installation environment. For example, in a high humidity condition, a decrease in the charge amount can be suppressed, however, in a low humidity condition, a problem arises that a charge amount increases too much.

### SUMMARY

According to an aspect of the invention, a developer having a toner containing a core toner including a colorant, a binder resin, a release agent and a charge controlling agent containing Al and Mg, and a conductive inorganic oxide having an intrinsic resistivity of from 1.0×10³Ω to 1.0×10¹⁰Ω which is externally added to the core toner in an amount of from 0.2 to 2.0 wt % based on the core toner, and a carrier for charging the toner is provided.

According to another aspect of the invention, an image forming apparatus including an image carrying body on which an electrostatic latent image is formed and a developing device having a developer reservoir configured to accommodate a developer having a toner which develops the electrostatic latent image on the image carrying body and a carrier for charging the toner is provided. The toner contains a core toner including a colorant, a binder resin, a release agent and a charge controlling agent containing Al and Mg, and a conductive inorganic oxide having an intrinsic resistivity of from 1.0×10³Ω to 1.0×10¹⁰Ω which is externally added to the core toner in an amount of from 0.2 to 2.0 wt % based on the core toner.

According to still another aspect of the invention, an image forming apparatus including an image carrying body on which an electrostatic latent image is formed, a developer reservoir configured to accommodate a developer having a toner and a carrier for charging the toner and having an evacuating section from which a portion of the developer is evacuated, a developing member configured to supply the developer in the developer reservoir to the image carrying body, a developer replenishing section configured to replenish the developer in the developer reservoir, a stirring and conveying member configured to stir the developer to effect circulation conveyance in the developer reservoir, and a toner concentration detector configured to detect the toner concentration in the developer. The toner contains a core toner including a colorant, a binder resin, a release agent and a charge controlling agent containing Al and Mg, and a conductive inorganic oxide having an intrinsic resistivity of from 1.0×10³Ω to 1.0×10¹⁰Ω which is externally added to the core toner in an amount of from 0.2 to 2.0 wt % based on the core toner.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrate an embodiment of the invention and together with the description, serve to explain the principles of the invention.

FIG. 1 is a structure of an image forming apparatus according to an embodiment of the invention;

FIG. 2 is a structure of an image forming unit of FIG. 1;

FIG. 3 is a cross-sectional view taken along the line A-A′ of FIG. 2;

FIG. 4 is a partial cross-sectional view taken along the line B-B′ of FIG. 3; and

FIG. 5 is a table showing compositions and evaluation results of developers of Examples and Comparative examples according to an embodiment of the invention.

### DETAILED DESCRIPTION

Reference will now be made in detail to the present embodiment of the invention, an example of which is illustrated in the accompanying drawings.

A developer of this embodiment has a toner containing a core toner including a colorant, a binder resin, a release agent and a charge controlling agent containing Al and Mg, and a conductive inorganic oxide having an intrinsic resistivity of from 1.0×10³Ω to 1.0×10¹⁰Ω which is externally added to the core toner in an amount of from 0.2 to 2.0 wt % based on the core toner, and a carrier for charging the toner.

In the core toner, as the colorant, carbon black, a yellow pigment which is generally used for a toner such as P.Y.180, P.Y.74, P.Y.17, P.Y.185 or P.Y.93, a magenta pigment which is generally used for a toner such as P.R.122, P.R.185, P.R.57:1, P.R.31, P.R.238, P.R.269, P.R.146, P.R.147, P.R.184 or P.V.19, a cyan pigment which is generally used for a toner such as P.B.15 or P.G.7 can be used.

As the binder resin, a polyester resin, a styrene-acrylic resin, a mixture thereof or the like is used.

When the polyester resin is used, the polyester resin can be obtained by using a monomer containing an acid component composed of a divalent or more polyvalent carboxylic acid compound and an alcohol component composed of a dihydric or more polyhydric alcohol.

Examples of the acid component include fumaric acid, maleic acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, succinic acids substituted with an alkyl group having from 1 to 20 carbon atoms or an alkenyl group having from 2 to 20 carbon atoms such as dodecenylsuccinic acid and octylsuccinic acid, and anhydrides of these acids, and these acids alkyl ester derivatives and the like.

Examples of the alcohol component include aliphatic polyols such as ethylene glycol, propylene glycol, 1,4-butanediol, 1,3-butanediol, 1,5-pentanediol, 1,6-hexanediol, neopentyl glycol, glycerin, trimethylolethane, trimethylolpropane and pentaerythritol; alicyclic polyols such as 1,4-cyclohexanediol and 1,4-cyclohexanedimethanol; and ethylene oxide or propylene oxide adducts such as bisphenol A.

When a styrene-acrylic resin is used, examples thereof include styrene polymers, styrene-diene copolymers and styrene-alkyl(meth)acrylate copolymers.

As the release agent, a natural wax such as carnauba wax or rice wax; a synthetic wax such as polypropylene wax or polyethylene wax can be used.

Further, the core toner contains a charge controlling agent (CCA) for controlling a frictional charge amount (charge amount). Examples of the charge controlling agent include metal-containing azo compounds, metal-containing salicylic acid derivative compounds and hydrophobized metal oxides, all of which contain Al and Mg. The charge controlling agent containing Al and Mg can suppress a decrease in the charge amount over time due to incorporation of Al and Mg therein as metal elements. In particular, when such a charge controlling agent is applied to a self-refreshing system mentioned below, a high charging property can be maintained regardless of the residence time of a deteriorated carrier. As the metal element, further, Fe, Cr or Zr may be contained therein. Further, one or more charge controlling agents of different types other than these can also be used in combination.

An addition amount of the charge controlling agent is preferably from 0.5 to 2 parts by weight based on 100 parts by weight of the binder resin. It is because if the addition amount is less than 0.5 parts by weight, it is difficult to impart a sufficient charging property, and if the addition amount exceeds 2 parts by weight, a charge amount increases too much particularly in a low humidity condition. More preferably, the addition amount is from 0.7 to 1.5 parts by weight.

As described above, a variation in the charge amount due to environment can be suppressed, therefore, a bulk density of a toner which varies depending on the charge amount can be made stable to some extent.

To the core toner surface, a conductive inorganic oxide having an intrinsic resistivity of from 1.0×10³Ω to 1.0×10¹⁰Ω is externally added. By allowing such a conductive inorganic oxide to exist on the core toner surface in this manner, a leak point of an electric charge is formed. Therefore, excessive charging of the core toner by the action of charge controlling agent or the like can be suppressed. Such a conductive inorganic oxide should be contained in an amount of from 0.2 to 2.0 wt % based on the core toner. It is because if the amount is less than 0.2 wt %, the charge amount particularly in a low humidity condition increases too much and the image density decreases, and if the amount exceeds 2.0 wt %, the charge amount decreases too much and fogging or toner scattering occurs thereby deteriorating an image quality.

As the conductive inorganic oxide, an oxide containing a metal such as Ti, Si, Al, St, Fe, Mn, Mg, Zn or Cu having an intrinsic resistivity of from 1.0×10³Ω to 1.0×10¹⁰Ω can be used. It is because if the intrinsic resistivity is less than 1.0×10³Ω, the charge amount decreases too much and fogging or toner scattering occurs thereby deteriorating an image quality, and if the intrinsic resistivity exceeds 1.0×10¹⁰Ω, the charge amount particularly in a low humidity condition increases too much and the image density decreases.

The conductive inorganic oxide preferably has an average particle diameter of from 8 to 100 nm. It is because if the average particle diameter is smaller than 8 nm, the conductive inorganic oxide is buried in the core toner surface and an electric charge cannot be released in some cases, and if the average particle diameter exceeds 100 nm, an adhesion force thereof to the core toner is decreased and the conductive inorganic oxide may be detached from the core toner surface in some cases. More preferably, the average particle diameter is from 12 to 30 nm.

It is preferred that to the core toner surface, further an inorganic oxide having an average particle diameter of from 70 to 200 nm which is a relatively large particle diameter is externally added. Due to a spacing effect, spent of toner components on the carrier can be suppressed. More preferably, the average particle diameter thereof is from 100 to 120 nm. As such a fine particle external additive, silica, titania, alumina, strontium titanate, tin oxide or the like can be used. Among these, silica is preferably used. As the silica, one which is produced by a baking method or a wetting method and is generally used for a toner can be used.

It is preferred that further a lubricant for a drum cleaner is externally added to the core toner surface. As the lubricant, a higher fatty acid salt of Zn, Ca, Mg or Al (metal soap), a resin containing fluorine or the like can be used.

The toner preferably has a volume average particle diameter of from 3 to 7 μm. If the volume average particle diameter is smaller than 3 μm, when an electric charge is imparted to the respective toner particles in an amount that can be controlled by an electric field, the charge amount per weight becomes too large, and therefore it becomes difficult to obtain a desired amount of development. If the volume average particle diameter is larger than 7 μm, reproducibility or graininess of a fine image is deteriorated. More preferably, the volume average particle diameter is from 4 to 6 μm.

As the carrier for charging such a toner, magnetic particles of ferrite, magnetite, iron oxide or the like, or resin particles mixed with magnetic powder thereof are used. A resin coating layer may be formed on a surface of the carrier.

The carrier preferably has a particle diameter of from 20 to 50 μm. If the particle diameter is smaller than 20 μm, since a magnetic force of one particle is small, the carrier is easily detached from a developer carrying body and adheres to a photoreceptor. On the other hand, if the particle diameter is larger than 50 μm, a magnetic brush hardens and brushing traces of the magnetic brush appear on an image or it becomes difficult to perform precise toner supply. More preferably, the particle diameter is from 25 to 40 μm.

Using such a developer, an image is formed by an image forming process such as a 4-drum tandem electrophotographic process.

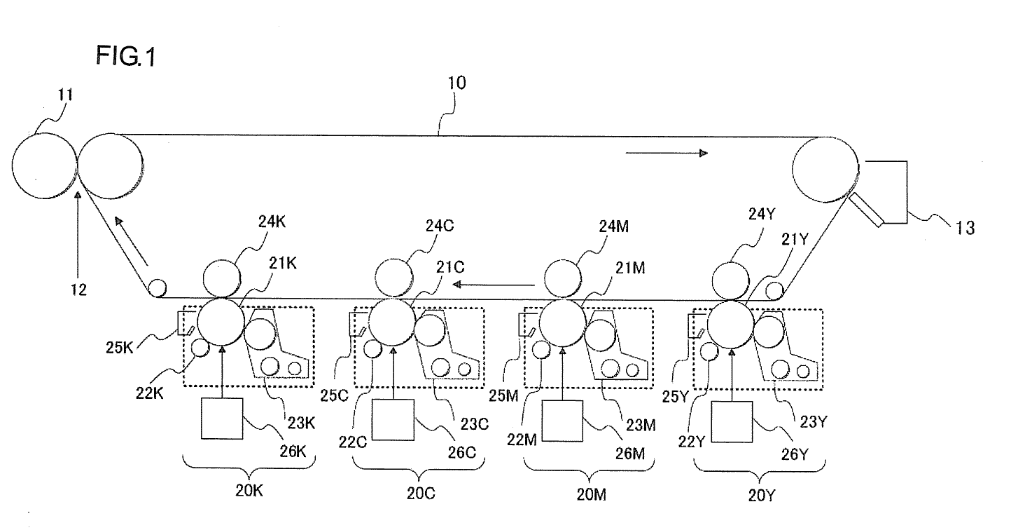

FIG. 1 shows a structure of a color printer according to this embodiment serving as an image forming apparatus to which a 4-drum tandem self-refreshing system is applied. As shown in FIG. 1, image forming units 20_{Y}, 20_{M}, 20_{C} and 20_{K} are arranged along in a conveying direction (arrow direction) of an intermediate transfer belt 10.

The image forming units 20_{Y}, 20_{M}, 20_{C} and 20_{K} are provided with photoreceptor drums 21_{Y}, 21_{M}, 21_{c} and 21_{K} serving as image carrying bodies (electrostatic latent image carrying bodies), respectively. As the photoreceptor, a known photoreceptor such as a positively charged or negatively charged OPC (organic photoconductor) or amorphous silicon is used.

The image forming units 20_{Y}, 20_{M}, 20_{C} and 20_{K} further have charging devices 22_{Y}, 22_{M}, 22_{C} and 22_{K} serving as charging units and developing rollers serving as developing members and the like around the respective photoreceptor drums, respectively, and each are provided with developing devices 23_{Y}, 23_{M}, 23_{C} and 23_{K} which accommodate developers containing carrier particles and toner particles of respective colors of yellow, magenta, cyan and black, respectively, primary transfer rollers 24_{Y}, 24_{M}, 24_{C} and 24_{K} serving as transfer units, and cleaners 25_{Y}, 25_{M}, 25_{C} and 25_{K} serving as cleaning units. These are arranged along in a rotating direction of the corresponding respective photoreceptor drums 21_{Y}, 21_{M}, 21_{C} and 21_{K}.

The respective primary transfer rollers 24_{Y}, 24_{M}, 24_{C} and 24_{K} are arranged inside the intermediate transfer belt 10, and sandwich the intermediate transfer belt 10 with the corresponding photoreceptor drums 21_{Y}, 21_{M}, 21_{C} and 21_{K}. Exposing devices 26_{Y}, 26_{M}, 26_{C} and 26_{K} are arranged such that an exposure point is formed between each of the charging devices 22_{Y}, 22_{M}, 22_{C} and 22_{K} and each of the developing devices 23_{Y}, 23_{M}, 23_{C} and 23_{K} on an outer circumferential surface of each of the photoreceptor drums 21_{Y}, 21_{M}, 21_{C} and 21_{K}. A secondary transfer roller 11 is arranged outside the intermediate transfer belt 10 such that it is in contact with the intermediate transfer belt 10.

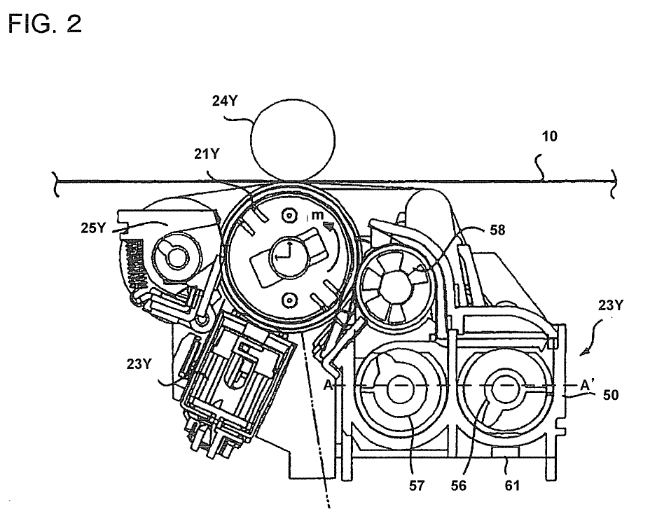

FIG. 2 shows a schematic structure of an image forming unit. Hereinafter, the image forming unit 20_{Y} will be described as a representative example. The other image forming units 20_{M}, 20_{C} and 20_{K} have the same configuration.

As shown in FIG. 2, the charging device 22_{Y}, the developing device 23_{Y} to which the self-refreshing system is applied, the primary transfer roller 24_{Y} and the cleaner 25_{Y} are arranged around the circumference of the photoreceptor drum 21_{Y}. The developing device 23_{Y} has a housing 50 serving as a developer reservoir for accommodating a developer 51, a developing roller 58 serving as a developing member, a first mixer 56 and a second mixer 57 each of which serves as a stirring and conveying device for stirring the developer 51 to effect circulation conveyance in the housing 50 and a toner concentration sensor 61 serving as a toner concentration detector for detecting the toner concentration in the developer in the housing 50.

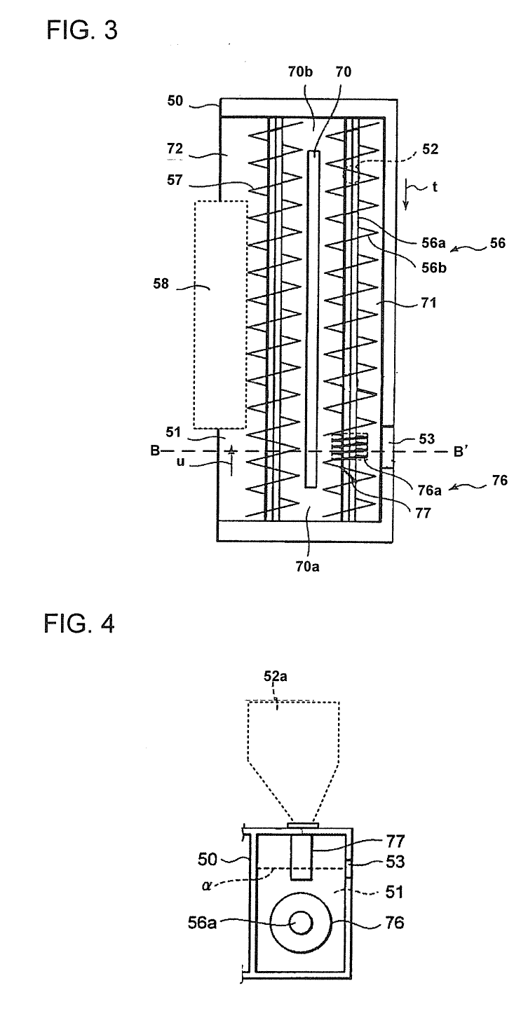

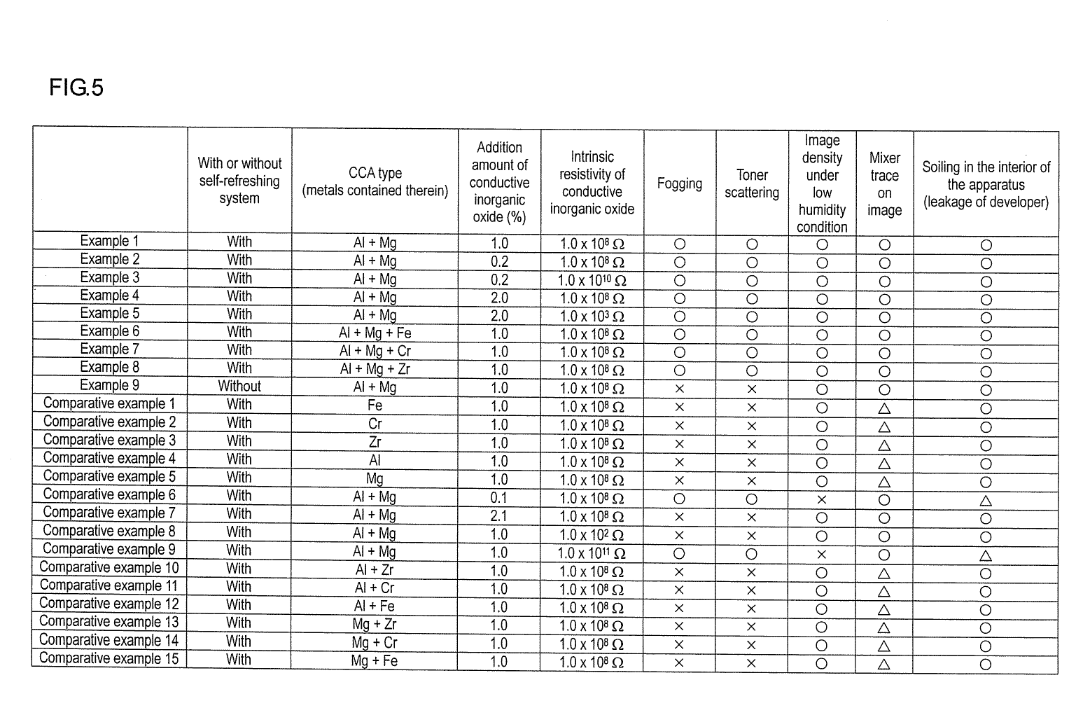

FIG. 3 shows a cross-sectional view taken along the line A-A′ of FIG. 2, and FIG. 4 shows a partial cross-sectional view taken along the line B-B′ of FIG. 3. A replenishing port 52 for the developer 51 is provided at an upper portion of the housing 50. A developer cartridge 52a indicated by a broken line serving as a developer replenishing section which accommodates and replenishes the developer 51 is installed at an upper portion of the replenishing port 52. An evacuation port 53 serving as a developer evacuating section from which the excessive developer 51 due to the replenishment of the developer 51 in the housing 50 is evacuated is provided at a side portion of the housing 50.

The housing 50 is partitioned by a partition plate 70 into a first stirring path 71 and a second stirring path 72 in which the first mixer 56 and the second mixer 57 both of which circulate and convey the developer are installed, respectively. The first stirring path 71 and the second stirring path 72 communicate with each other via a first communicating portion 70a and a second communicating portion 70b. The first mixer 56 is constituted by a shaft 56a and a blade 56b. An evacuating mixer 76 having a blade 76a with a smaller diameter and a narrower pitch than those of the blade 56b is provided to the shaft 56a at a position facing the evacuation port 53. A contact rotary plate 77 serving as a controlling member for preventing a variation in the evacuation amount due to environmental change of the developer 51 is provided on a downstream side of the evacuation port 53 such that a lower end of the contact rotary plate 77 is positioned at a predetermined height.

Using such an image forming apparatus, an image is formed as described below. First, the charging device 22_{Y} negatively charges the photoreceptor drum 21_{Y} uniformly. On the charged photoreceptor drum 21_{Y}, an electrostatic latent image is formed by performing exposure according to image information by the exposing device 26_{Y}.

In the developing device 23_{Y}, the developer 51 in the housing 50 is circulated and conveyed by the first mixer 56 and the second mixer 57 in the directions t and u, respectively, and supplied to the photoreceptor drum 21_{Y} by the developing roller 58. The electrostatic latent image on the photoreceptor drum 21_{Y} is reversely developed by the developing device 23_{Y}, and a toner image is formed on the photoreceptor drum 21_{Y}.

A bias voltage (+) having a polarity opposite to that of the toner is applied to the primary transfer roller 24_{Y} by a power source (not shown), and a transfer electric field is formed between the photoreceptor drum 21_{Y} and the primary transfer roller 24_{Y}. As a result, the toner image on the photoreceptor drum 21_{Y} is primarily transferred to the intermediate transfer belt 10 by the transfer electric field when the toner image passes between the photoreceptor drum 21_{Y} and the primary transfer roller 24_{Y}. On the photoreceptor drum 21_{Y} after the transfer, after cleaning is performed by the cleaner 25_{Y}, the process of charging, exposure and development is repeated again.

As the development is performed in this manner, the toner in the developer 51 is consumed. When a decrease in the toner concentration in the developer 51 is detected by the toner concentration sensor 61, a fresh developer is replenished by the developer cartridge 52a.

At this time, the carrier concentration in the developer 51 in the developer cartridge 52a is preferably from 5 to 30 wt %. It is because if the carrier concentration is less than 5 wt %, for example, when printing is performed at low coverage, a refreshing effect cannot be sufficiently obtained in some cases, and if the carrier concentration exceeds 30 wt %, for example, when printing is performed at high coverage, the carrier is excessively replenished and the amount of the developer becomes too much in some cases.

By the replenishment of the developer, the toner concentration in the developer is maintained in a predetermined range. At this time, the carrier concentration in the thus controlled developer is preferably from 88 to 96 wt %. If the carrier concentration is less than 88 wt %, the toner concentration in the developer is too high, and therefore, the entire toner cannot be sufficiently charged and fogging or toner scattering occurs in some cases. If the carrier concentration exceeds 96 wt %, the toner concentration is too low, and therefore, a sufficient image density is not obtained in some cases. More preferably, the carrier concentration is from 90 to 94 wt %.

By the replenishment of the fresh developer 51, the excessive developer 51 is evacuated from the evacuation port 53. At this time, the flow rate of the developer 51 is decreased because the blade 76a of the evacuating mixer 76 has a smaller diameter and a narrower pitch than those of the blade 56b of the first mixer 56. Since the flow rate of the developer 51 is decreased, the developer 51 accumulates at a position facing the evacuation port 53. The developer 51 raised from the height of the lower end of the evacuation port 53 to the height of the broken line α due to accumulation is evacuated from the evacuation port 53.

At this time, the height of the raised developer 51 somewhat varies depending on the environmental change such as humidity change. To cope with this, the contact rotary plate 77 serving as a controlling member prevents a variation in the evacuation amount. Further, an environment detector configured to detect an environmental condition such as humidity may be provided such that the evacuation amount of the developer from the evacuating section can be controlled by the controlling member based on the detection results of the environment detector. As described above, by the self-refreshing system, the fresh developer is replenished according to the consumption of the toner and the deteriorated developer in an amount corresponding to the replenished amount is evacuated.

In this manner, the toner image is formed in the image forming unit 20_{Y}. In accordance with the timing of the toner image formation in the image forming unit 20_{Y}, the same process is performed also in the image forming units 20_{M}, 20_{C} and 20_{K}. The magenta, cyan and black toner images formed on the photoreceptors in the image forming units 20_{M}, 20_{C} and 20_{K} are also sequentially primarily transferred to the intermediate transfer belt 10.

A transfer medium 12 is conveyed from a cassette (not shown) and fed to the intermediate transfer belt 10 by an aligning roller (not shown) in accordance with the timing of the toner image on the intermediate transfer belt 10.

A bias voltage (+) having a polarity opposite to that of the toner is applied to the secondary transfer roller 11 by a power source (not shown). As a result, the toner image on the intermediate transfer belt 10 is transferred to the transfer medium 12 by a transfer electric field formed between the intermediate transfer belt 10 and the secondary transfer roller 11. A fixing device (not shown) which fixes the toner transferred to the transfer medium 12 is provided in the apparatus, and by passing the transfer medium 12 through the fixing device, a fixed image is obtained.

At this time, a portion of the toner (residual transfer toner) which is not completely transferred to the transfer medium 12 and remains on the intermediate transfer belt 10 is cleaned by the cleaner 13.

In the example described above, the image forming units are arranged in the order of yellow, magenta, cyan and black. However, the order of colors is not particularly limited. When a cleanerless process without resort to a cleaner is used, the residual transfer toner is recovered simultaneously with the development. When the self-refreshing system is not used, the developer is not automatically replenished or evacuated but replaced at a predetermined cycle.

Hereinafter, the invention will be specifically described with reference to Examples.

### Example 1

Based on a polyester resin, 4 wt % carnauba wax as a release agent, 5 wt % carbon black as a colorant and 1.5 wt % CCA containing Al and Mg are mixed using a Henschel mixer. The resulting mixture is further kneaded using an extrusion-type melt kneader, and then, the kneaded product is pulverized and sieved, whereby a core toner is formed.

To this core toner, as a conductive inorganic oxide, titanium oxide having an intrinsic resistivity of 1.0×10⁸Ω in an amount of 1.0 wt % based on the core toner is added. Further, 1 wt % silica and 0.1 wt % a metal soap as a lubricant for a drum cleaner are added thereto, and these are mixed using a Henschel mixer for a predetermined time, whereby these components are added externally to the core toner.

To the thus obtained toner, a ferrite carrier is added such that the carrier concentration is 92 wt %, whereby a developer is prepared. The resulting developer is evaluated as follows. The respective evaluations are performed using a multifunction machine e-STUDIO 103500C manufactured by Toshiba in a test environment where the temperature is set to 20 to 25° C., and the humidity is set to 40 to 60%. Each evaluation is performed after 300000 sheets of A4 paper are printed at 8% coverage using a black toner. In the printing of 300000 sheets of paper, for obtaining data applied with the self-refreshing system, a predetermined amount of the developer is manually replaced every 1000 sheet printing.

### Evaluation for Fogging

After 300000 sheets of paper are printed, a fogging density on a sheet of A3 white paper copy is measured using a photovolt, and a case where the fogging density is less than 2% is evaluated as ◯, and a case where it is 2% or more is evaluated as X.

### Evaluation for Toner Scattering

An image is obtained after 300000 sheets of paper are printed, and toner scattering on the image is evaluated. A case where soiling such as toner dropping or the like caused by toner scattering is not observed is evaluated as ◯, a case where it is observed is evaluated as X, and a case where toner dropping is not observed, but slight soiling is observed in the interior of the apparatus is evaluated as Δ.

### Evaluation for Image Density Under Low Humidity Condition

After 300000 sheets of paper are printed, the apparatus is left in an environment where the temperature is set to 10° C. and the humidity is set to 20% for 24 hours, and thereafter, a solid image is outputted. A density of the outputted image is measured using MacBeth 191, and a case where the measurement value is 1.3 or more is evaluated as ◯, and a case where it is less than 1.3 is evaluated as X.

### Evaluation for Mixer Trace on Image

With respect to a monochromatic solid image outputted after 300000 sheets of paper are printed in the evaluation for image density, a case where there is no problem on the image is evaluated as ◯, a case where a slight mixer trace is observed on the image is evaluated as Δ, and a case where a clear mixer trace is observed on the image is evaluated as X.

### Evaluation for Soiling in the Interior of the Apparatus (Leakage of Developer)

After 300000 sheets of paper are printed, a case where the interior of the apparatus is not at all soiled due to leakage of developer is evaluated as ◯, a case where it is slightly soiled due to leakage of developer is evaluated as Δ, and a case where it is significantly soiled due to leakage of developer is evaluated as X.

As a result of these evaluations, as shown in FIG. 5, the developer of Example 1 shows good properties with respect to all the evaluation items.

### Example 2

A toner is formed in the same manner as in Example 1 except that the addition amount of the conductive inorganic oxide is set to 0.2 wt %, and evaluations are performed in the same manner as in Example 1. As shown in FIG. 5, the resulting developer shows good properties with respect to all the evaluation items.

### Example 3

A toner is formed in the same manner as in Example 2 except that the intrinsic resistivity of the conductive inorganic oxide is set to 1.0×10¹⁰Ω, and evaluations are performed in the same manner as in Example 1. As shown in FIG. 5, the resulting developer shows good properties with respect to all the evaluation items.

### Example 4

A toner is formed in the same manner as in Example 1 except that the addition amount of the conductive inorganic oxide is set to 2.0 wt %, and evaluations are performed in the same manner as in Example 1. As shown in FIG. 5, the resulting developer shows good properties with respect to all the evaluation items.

### Example 5

A toner is formed in the same manner as in Example 4 except that the intrinsic resistivity of the conductive inorganic oxide is set to 1.0×10³Ω, and evaluations are performed in the same manner as in Example 1. As shown in FIG. 5, the resulting developer shows good properties with respect to all the evaluation items.

### Example 6

A toner is formed in the same manner as in Example 1 except that CCA containing Al, Mg and Fe is used, and evaluations are performed in the same manner as in Example 1. As shown in FIG. 5, the resulting developer shows good properties with respect to all the evaluation items.

### Example 7

A toner is formed in the same manner as in Example 1 except that CCA containing Al, Mg and Cr is used, and evaluations are performed in the same manner as in Example 1. As shown in FIG. 5, the resulting developer shows good properties with respect to all the evaluation items.

### Example 8

A toner is formed in the same manner as in Example 1 except that CCA containing Al, Mg and Zr is used, and evaluations are performed in the same manner as in Example 1. As shown in FIG. 5, the resulting developer shows good properties with respect to all the evaluation items.

### Example 9

A toner is formed in the same manner as in Example 1, and evaluations are performed in the same manner as in Example 1 after 300000 sheets of A4 paper are printed at 8% coverage using a black toner without replacing the developer. Since the self-refreshing system is not applied, as shown in FIG. 5, in the evaluations with respect to fogging and toner scattering, slight deterioration is observed. However, the resulting developer shows good properties with respect to image density under low humidity condition, mixer trace on image and soiling in the interior of the apparatus.

### Comparative example 1

A toner is formed in the same manner as in Example 1 except that CCA not containing Al and Mg but containing Fe is used, and evaluations are performed in the same manner as in Example 1. As shown in FIG. 5, the resulting developer shows good results in the evaluations for image density under low humidity condition and soiling in the interior of the apparatus. However, because CCA does not contain Al and Mg, fogging and toner scattering occur, and also slight deterioration is observed with respect to mixer trace on image.

### Comparative Example 2

A toner is formed in the same manner as in Example 1 except that CCA not containing Al and Mg but containing Cr is used, and evaluations are performed in the same manner as in Example 1. As shown in FIG. 5, the resulting developer shows good results in the evaluations for image density under low humidity condition and soiling in the interior of the apparatus. However, because CCA does not contain Al and Mg, fogging and toner scattering occur, and also slight deterioration is observed with respect to mixer trace on image.

### Comparative Example 3

A toner is formed in the same manner as in Example 1 except that CCA not containing Al and Mg but containing Zr is used, and evaluations are performed in the same manner as in Example 1. As shown in FIG. 5, the resulting developer shows good results in the evaluations for image density under low humidity condition and soiling in the interior of the apparatus. However, because CCA does not contain Al and Mg, fogging and toner scattering occur, and also slight deterioration is observed with respect to mixer trace on image.

### Comparative Example 4

A toner is formed in the same manner as in Example 1 except that CCA not containing Mg but containing only Al is used, and evaluations are performed in the same manner as in Example 1. As shown in FIG. 5, the resulting developer shows good results in the evaluations for image density under low humidity condition and soiling in the interior of the apparatus. However, because CCA does not contain Mg, fogging and toner scattering occur, and also slight deterioration is observed with respect to mixer trace on image.

### Comparative Example 5

A toner is formed in the same manner as in Example 1 except that CCA not containing Al but containing only Mg is used, and evaluations are performed in the same manner as in Example 1. As shown in FIG. 5, the resulting developer shows good results in the evaluations for image density under low humidity condition and soiling in the interior of the apparatus. However, because CCA does not contain Al, fogging and toner scattering occur, and also slight deterioration is observed with respect to mixer trace on image.

### Comparative Example 6

A toner is formed in the same manner as in Example 1 except that the addition amount of the conductive inorganic oxide is set to 0.1 wt %, and evaluations are performed in the same manner as in Example 1. As shown in FIG. 5, the resulting developer shows good results in the evaluations for fogging, toner scattering, and mixer trace on image. However, because the addition amount of the conductive inorganic oxide is too small, a sufficient image density under low humidity condition cannot be obtained, and also slight deterioration is observed with respect to soiling in the interior of the apparatus.

### Comparative Example 7

A toner is formed in the same manner as in Example 1 except that the addition amount of the conductive inorganic oxide is set to 2.1 wt %, and evaluations are performed in the same manner as in Example 1. As shown in FIG. 5, the resulting developer shows good results in the evaluations for image density under low humidity condition, mixer trace on image, and soiling in the interior of the apparatus. However, because the addition amount of the conductive inorganic oxide is too large, the occurrence of fogging and toner scattering is observed.

### Comparative Example 8

A toner is formed in the same manner as in Example 1 except that the intrinsic resistivity of the conductive inorganic oxide is set to 1.0×10²Ω, and evaluations are performed in the same manner as in Example 1. As shown in FIG. 5, the resulting developer shows good results in the evaluations for image density under low humidity condition, mixer trace on image, and soiling in the interior of the apparatus. However, because the intrinsic resistivity of the conductive inorganic oxide is too low, the occurrence of fogging and toner scattering is observed.

### Comparative Example 9

A toner is formed in the same manner as in Example 1 except that the intrinsic resistivity of the conductive inorganic oxide is set to 1.0×10¹¹Ω, and evaluations are performed in the same manner as in Example 1. As shown in FIG. 5, the resulting developer shows good results in the evaluations for fogging, toner scattering, and mixer trace on image. However, because the intrinsic resistivity of the conductive inorganic oxide is too high, a sufficient image density under low humidity condition cannot be obtained, and also slight deterioration is observed with respect to soiling in the interior of the apparatus.

good results in the evaluations for the occurrence of fogging, toner scattering, and mixer trace on image image density under low humidity condition occur, is observed and soiling in the interior of the apparatus

### Comparative Example 10

A toner is formed in the same manner as in Example 1 except that CCA not containing Mg but containing Al and Zr is used, and evaluations are performed in the same manner as in Example 1. As shown in FIG. 5, the resulting developer shows good results in the evaluations for image density under low humidity condition and soiling in the interior of the apparatus. However, because CCA does not contain Mg, fogging and toner scattering occur, and also slight deterioration is observed with respect to mixer trace on image.

### Comparative Example 11

A toner is formed in the same manner as in Example 1 except that CCA not containing Mg but containing Al and Cr is used, and evaluations are performed in the same manner as in Example 1. As shown in FIG. 5, the resulting developer shows good results in the evaluations for image density under low humidity condition and soiling in the interior of the apparatus. However, because CCA does not contain Mg, fogging and toner scattering occur, and also slight deterioration is observed with respect to mixer trace on image.

### Comparative Example 12

A toner is formed in the same manner as in Example 1 except that CCA not containing Mg but containing Al and Fe is used, and evaluations are performed in the same manner as in Example 1. As shown in FIG. 5, the resulting developer shows good results in the evaluations for image density under low humidity condition and soiling in the interior of the apparatus. However, because CCA does not contain Mg, fogging and toner scattering occur, and also slight deterioration is observed with respect to mixer trace on image.

### Comparative Example 13

A toner is formed in the same manner as in Example 1 except that CCA not containing Al but containing Mg and Zr is used, and evaluations are performed in the same manner as in Example 1. As shown in FIG. 5, the resulting developer shows good results in the evaluations for image density under low humidity condition and soiling in the interior of the apparatus. However, because CCA does not contain Al, fogging and toner scattering occur, and also slight deterioration is observed with respect to mixer trace on image.

### Comparative Example 14

A toner is formed in the same manner as in Example 1 except that CCA not containing Al but containing Mg and Cr is used, and evaluations are performed in the same manner as in Example 1. As shown in FIG. 5, the resulting developer shows good results in the evaluations for image density under low humidity condition and soiling in the interior of the apparatus. However, because CCA does not contain Al, fogging and toner scattering occur, and also slight deterioration is observed with respect to mixer trace on image.

### Comparative Example 15

A toner is formed in the same manner as in Example 1 except that CCA not containing Al but containing Mg and Fe is used, and evaluations are performed in the same manner as in Example 1. As shown in FIG. 5, the resulting developer shows good results in the evaluations for image density under low humidity condition and soiling in the interior of the apparatus. However, because CCA does not contain Al, fogging and toner scattering occur, and also slight deterioration is observed with respect to mixer trace on image.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A developer comprising:
a toner containing a core toner including a colorant, a binder resin, a release agent and a charge controlling agent containing Al and Mg, and a conductive inorganic oxide having an intrinsic resistivity of from 1.0×10³Ω to 1.0×10¹⁰Ω, the conductive inorganic oxide externally added to the core toner in an amount of from 0.2 to 2.0 wt % based on the core toner; and
a carrier for charging the toner.

2. The developer according to claim 1, wherein the carrier is contained in an amount of from 5 to 30 wt % based on the developer.

3. The developer according to claim 1, wherein the toner further contains an inorganic oxide having an average primary particle diameter of from 70 to 200 nm, and the conductive inorganic oxide externally added to the core toner in an amount of from 0.2 to 2.0 wt % based on the core toner.

4. The developer according to claim 3, wherein the inorganic oxide is silica.

5. The developer according to claim 1, wherein the charge controlling agent further contains Fe, Cr or Zr.

6. The developer according to claim 1, wherein the conductive inorganic oxide contains Ti, Si, Al, St, Fe, Mn, Mg, Zn or Cu.

7. The developer according to claim 1, wherein the toner further contains a lubricant.

8. The developer according to claim 1, wherein the developer is used in a self-refreshing system.

9. An image forming apparatus comprising:
an image carrying body for forming an electrostatic latent image on the image carrying body; and
a developing device having a developer reservoir configured to accommodate a developer having a toner for developing the electrostatic latent image on the image carrying body and a carrier for charging the toner, the toner containing a core toner including a colorant, a binder resin, a release agent and a charge controlling agent containing Al and Mg, and a conductive inorganic oxide having an intrinsic resistivity of from 1.0×10³Ω to 1.0×10¹⁰Ω, the conductive inorganic oxide externally added to the core toner in an amount of from 0.2 to 2.0 wt % based on the core toner.

10. The apparatus according to claim 9, wherein the carrier concentration in the developer in the developer reservoir is from 88 to 96 wt % based on the developer.

11. The apparatus according to claim 9, wherein the toner further contains an inorganic oxide having an average primary particle diameter of from 70 to 200 nm, and the conductive inorganic oxide externally added to the core toner in an amount of from 0.2 to 2.0 wt % based on the core toner.

12. The apparatus according to claim 9, wherein the charge controlling agent further contains Fe, Cr or Zr.

13. The apparatus according to claim 9, wherein the conductive inorganic oxide contains Ti, Si, Al, St, Fe, Mn, Mg, Zn or Cu.

14. An image forming apparatus comprising:
an image carrying body for forming an electrostatic latent image on the image carrying body;
a developer reservoir configured to accommodate a developer having a toner for developing the electrostatic latent image on the image carrying body, and a carrier for charging the toner, the toner containing a core toner including a colorant, a binder resin, a release agent and a charge controlling agent containing Al and Mg, and a conductive inorganic oxide having an intrinsic resistivity of from 1.0×10³Ω to 1.0×10¹⁰Ω, the conductive inorganic oxide externally added to the core toner in an amount of from 0.2 to 2.0 wt % based on the core toner, the developer reservoir having an evacuating section for evacuating the developer;
a developing member configured to supply the developer in the developer reservoir to the image carrying body;
a developer replenishing section configured to replenish the developer in the developer reservoir;
a stirring and conveying member configured to stir the developer to effect circulation conveyance in the developer reservoir; and
a toner concentration detector configured to detect the toner concentration in the developer.

15. The apparatus according to claim 14, wherein the carrier concentration in the developer in the developer reservoir is from 88 to 96 wt % based on the developer.

16. The apparatus according to claim 14, wherein the carrier concentration in the developer to be replenished in the developer reservoir is from 5 to 30 wt % based on the developer.

17. The apparatus according to claim 14, wherein the toner further contains an inorganic oxide having an average primary particle diameter of from 70 to 200 nm which is externally added to the core toner in an amount of from 0.2 to 2.0 wt % based on the core toner.

18. The apparatus according to claim 14, wherein the charge controlling agent further contains Fe, Cr or Zr.

19. The apparatus according to claim 14, wherein the developer is replenished in the developer reservoir from the developer replenishing section based on the detected toner concentration.

20. The apparatus according to claim 14 further comprising an environment detector configured to detect an environmental condition and a controlling member configured to control the evacuation amount of the developer from the evacuating section based on the detection result of the environment detector.
